(19) United States
(12) Patent Application Publication
(10) Pub. No.: US 2026/0159127 A1
(43) Pub. Date: Jun. 11, 2026

(54) DRIVING STRATEGY LEARNING SYSTEM AND METHOD BASED ON UNIFIED VISION-LANGUAGE PERCEPTION IN REAL-TIME DRIVING ENVIRONMENT

(71) Applicant: ELECTRONICS AND TELECOMMUNICATIONS RESEARCH INSTITUTE, Daejeon (KR)

(72) Inventors: Jinwoo KIM, Daejeon (KR); Kyoung-Wook Min, Daejeon (KR); Kyoung Hwan AN, Daejeon (KR)

(21) Appl. No.: 19/409,467

(22) Filed: Dec. 4, 2025

(30) Foreign Application Priority Data
Dec. 9, 2024 (KR) 10-2024-0181537
Nov. 11, 2025 (KR) 10-2025-0169480

(51) Int. Cl. B60W 60/00; B60W 30/09; B60W 30/095; B60W 30/18; B60W 40/08; B60W 40/09; B60W 50/00; G06T 7/11; G06T 7/50; G06V 10/26; G06V 20/58

(52) U.S. Cl. CPC B60W 60/0011; B60W 30/09; B60W 30/0956; B60W 30/18163; B60W 40/09; B60W 50/0097; B60W 60/0015; B60W 60/00274; G06T 7/11; G06T 7/50; G06V 10/26; G06V 20/58; B60W 2040/0818; B60W 2420/403; B60W 2420/408; B60W 2540/049; B60W 2554/20; B60W 2554/4045; B60W 2554/80; B60W 2556/40; B60W 2556/50; G06T 2207/10028; G06T 2207/30261

(57) ABSTRACT

Disclosed are a driving strategy learning system and method based on unified vision-language perception in a real-time driving environment. The driving strategy learning system includes an input information processing unit configured to collect and pre-process multi-sensor data, an environment perception and decision unit configured to interpret a driving environment and to perform a driving decision based on a unified vision-language mode (VLM), a driving controller configured to generate and execute a vehicle control instruction based on the driving decision, and an auxiliary information processor configured to support a driving strategy decision by integrating auxiliary information including at least any one of a navigation route, vehicle and passenger statuses, and a time to collision (TTC)-based collision risk index.

### CROSS-REFERENCE TO RELATED APPLICATIONS

This application claims priority to and the benefit of Korean Patent Applications Nos. 10-2024-0181537 filed on Dec. 9, 2024, and 10-2025-0169480 filed on Nov. 11, 2025, the disclosures of which are incorporated herein by reference in their entirety.

### BACKGROUND

### 1. Technical Field

The present disclosure relates to a driving strategy learning system and method based on unified vision-language perception in a real-time driving environment.

### 2. Description of Related Art

An autonomous driving system according to a conventional technology has problems in that an immediate decision on a complex road condition is difficult because the autonomous driving system adopts a structure in which individual sensor data from a camera, LiDAR, and a GPS is independently processed and then integrated based on a rule and real time is reduced because perception and a decision are separated. A vision-language model (VLM) enables a situation to be understood in a way similar to a human by integrally processing an image and a natural language, but still has technical limitations in being applied to a real-time driving environment. Accordingly, there is a need for a real-time learning technology based on unified vision-language perception, in which an environment is understood by integrating and analyzing multi-sensor data and a driving strategy is directly learnt based on the understood environment.

### SUMMARY

Various embodiments are directed to providing a driving strategy learning system and method based on unified vision-language perception in a real-time driving environment, in which a driving environment is understood by integrating and analyzing multi-sensor data in real time through the unified VLM and a driving strategy is autonomously learnt and optimized by reflecting feedback from a human driver.

However, technical objects to be achieved by the present disclosure are not limited to the aforementioned object, and the other objects not described above may be evidently understood from the following description by those skilled in the art.

A driving strategy learning system based on unified vision-language perception in a real-time driving environment according to an embodiment of the present disclosure includes an input information processing unit configured to collect and pre-process multi-sensor data, an environment perception and decision unit configured to interpret a driving environment and to perform a driving decision based on a unified vision-language mode (VLM), a driving controller configured to generate and execute a vehicle control instruction based on the driving decision, and an auxiliary information processor configured to support a driving strategy decision by integrating auxiliary information including at least any one of a navigation route, vehicle and passenger statuses, and a time to collision (TTC)-based collision risk index.

In an embodiment, the input information processing unit includes an input information collection module configured to collect driving environment data through a plurality of sensors including a multi-camera, long-range LiDAR, short-range LiDAR, and a GPS and a segmentation and depth map generation module configured to detect the region of an object and to generate a depth map based on the multi-sensor data.

In an embodiment, the environment perception and decision unit includes a vision large language model (LLM) perception and decision module configured to decide whether an obstacle is present around a vehicle and decide a Ready, Action, Start, or Cancel state, a description update module configured to describe a perception result in a natural language form and to represent a risk factor by highlighting the risk factor, and a human live feedback module configured to collect feedback from a driver in real time during driving and to reflect the feedback in a decision.

In an embodiment, the vision LLM perception and decision module predicts a motion of an interest target by performing multi-frame-based target tracking and analyzes avoidance possibility by separately identifying a static obstacle and a dynamic obstacle.

In an embodiment, the human live feedback module converts the feedback of the driver in a voice or text form into machine learning data by classifying and analyzing the feedback during driving.

In an embodiment, the driving controller includes a current position check module configured to calculate a current position of a vehicle by performing vehicle perception, preceding vehicle tracking, and road width calculation, a basic driving environment control module configured to perform steering, acceleration, braking, and speed control, and an advanced driving training module configured to establish an advanced driving strategy.

In an embodiment, the basic driving environment control module and the advanced driving training module optimize a result of basic control as an advanced strategy by performing an exchange of bidirectional information. The advanced strategy is established within an executable range by considering limitations of the basic control.

In an embodiment, the auxiliary information processor includes a navigation map module configured to calculate an optimal route to a destination and to update recommendation lane and turning information by reflecting real-time traffic information, an advanced condition decision module configured to monitor the number of passengers within a vehicle, a degree of fatigue, and a vehicle performance state, and a basic behavior decision module configured to evaluate the level of a collision risk by calculating a TTC value.

In an embodiment, the basic behavior decision module decides the execution possibility of U turning, avoidance, and a lane change by considering a turning radius and road occupancy by lane and transmits a safe stop distance calculation result to the driving controller.

In an embodiment, a bidirectional information exchange path is formed between the environment perception and decision unit and the driving controller so that a perception result is reflected in real-time driving control and a control result is used to improve perception accuracy again.

In an embodiment, the environment perception and decision unit includes a priority and emergency level decision module configured to receive decision information generated by a vision LLM perception and re-decision module and a human live feedback module, to evaluate emergency and priority levels of a situation, and to dynamically adjust processing priority.

In an embodiment, the priority and emergency level decision module calculates the emergency and priority levels for each situation by integrating a perception result of the vision LLM perception and re-decision module and feedback data of the human live feedback module and performs real-time prompt updates when each situation is classified as an emergency situation.

In an embodiment, the priority and emergency level decision module preferentially transmits an instruction to each module of the driving controller by immediately triggering emergency control when an emergency situation occurs, and accumulates and stores feedback data and reflects the feedback data in a learning of the driving strategy in a common situation.

A driving strategy learning method based on unified vision-language perception in a real-time driving environment according to an embodiment of the present disclosure includes collecting driving environment data from a multi-modal sensor, perceiving an object and generating space information including a depth map based on the collected driving environment data, interpreting a driving environment and deciding a situation by using a unified vision-language model (VLM), determining the driving state of a vehicle and generating a control instruction including steering, acceleration, braking, and speed control based on a result of the situation decision, optimizing a driving strategy by integrating auxiliary information including at least any one of a navigation route, vehicle and passenger statuses, and a time to collision (TTC)-based collision risk index, and updating the unified VLM by reflecting a driving result and human feedback and performing a learning of the driving strategy.

In an embodiment, the collecting of the driving environment data from the multi-modal sensor includes collecting data covering front, rear, and side areas of the vehicle through a multi-modal sensor including a camera, LiDAR, and a GPS at a preset cycle or less and pre-processing the driving environment data in a synchronized form by performing time axis alignment and coordinate conversion on the driving environment data.

In an embodiment, the perceiving of the object and the generating of the space information including the depth map includes segmenting input image data in a pixel unit by using a segmentation and depth map generation module and mapping a position and depth of each object on a three-dimensional coordinate system by detecting boundaries between a road, a vehicle, a pedestrian, and an obstacle.

In an embodiment, the interpreting of the driving environment and deciding of the situation by using the unified VLM includes integrating and analyzing visual information and language information through a vision LLM perception and decision module, generating a natural language description for a current situation by synthesizing a motion of the object, a road form, and a signal state, assigning emergency and priority levels of an event through a priority and emergency level decision module when a risk factor is detected, and outputting an immediate control instruction generation signal by performing real-time prompt updates when the current situation is classified as an emergency situation.

In an embodiment, the interpreting of the driving environment and deciding of the situation by using the unified VLM includes collecting intuitive judgment information of a driver through a human live feedback module, re-adjusting a unified vision-language perception result by reflecting the intuitive judgment information in learning data, and generating an immediate control instruction when an emergency situation occurs by evaluating priority and emergency levels of an event through a priority and emergency level decision module.

In an embodiment, the determining of the driving state of the vehicle and generating of the control instruction based on the situation decision result includes calculating vehicle perception, preceding vehicle tracking, and a road width through a current position check module, generating a control instruction including steering, acceleration, and braking through a basic driving environment control module and an advanced driving training module, and performing an immediate control instruction within a preset response time or less in an emergency situation.

In an embodiment, the navigation route, the optimizing of the driving strategy by integrating the auxiliary information includes providing destination route and recommended lane information through a navigation map module, reflecting vehicle performance and a passenger status through an advanced condition decision module, deciding whether to avoid a collision by calculating a TTC value through a basic behavior decision module, and performing at least one of urgent stop control and avoidance control.

According to embodiments of the present disclosure, it is possible to effectively solve information transfer latency and decision mismatch problems which occur in the existing module-separate autonomous driving technology because the perception, decision, and control steps of an autonomous driving system are combined into one integrated structure based on the unified VLM.

According to embodiments of the present disclosure, understanding of a driving environment at a human level and a situation description based on a natural language are made possible because data collected from various sensors, such as a camera, LiDAR, and a GPS, is integrated and processed based on the unified VLM. Accordingly, a vehicle can establish an immediate counterstrategy by autonomously analyzing various situations occurring during driving and perceiving a risk factor.

Furthermore, by incorporating real-time feedback from a human driver into the learning process, the driving strategy learning system continuously improves its performance through iterative experiences and autonomously learns driving strategies optimized for actual road driving conditions.

In particular, the precision of a driving strategy can be improved because emergency control is immediately performed in a high-risk situation and accumulated data is used as learning data in a common situation by rapidly evaluating the emergency priority level of a situation.

According to embodiments of the present disclosure, autonomous driving in which safety, adaptability, and efficiency are balanced by using the time to collision (TTC)-based collision avoidance function, the navigation information integration function, and the vehicle and passenger status evaluation function.

According to embodiments of the present disclosure, safe and reliable driving can be realized by providing an advanced learning type autonomous driving technology which can overcome the limitations of the existing rule-based autonomous driving system and reflect the intuitive judgment of a human driver.

However, effects of the present disclosure which may be obtained in the present disclosure are not limited to the aforementioned effects, and other effects not described above may be evidently understood by those skilled in the art from the following description.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings.

FIG. 1 illustrates a driving strategy learning system based on unified vision-language perception in a real-time driving environment according to an embodiment of the present disclosure.

FIG. 2 is a detailed configuration diagram of the driving strategy learning system based on unified vision-language perception in a real-time driving environment according to an embodiment of the present disclosure.

FIG. 3 illustrates a data processing structure including a vision LLM perception and re-decision module, a human live feedback module, and a priority and emergency level decision module according to another embodiment of the present disclosure.

FIG. 4 illustrates a driving strategy learning method based on unified vision-language perception in a real-time driving environment according to an embodiment of the present disclosure.

FIG. 5 is a block diagram illustrating a computer system for implementing a method according to an embodiment of the present disclosure.

### DETAILED DESCRIPTION

The aforementioned object, other objects, advantages, and characteristics of the present disclosure and a method for achieving the objects, advantages, and characteristics will become clear with reference to embodiments to be described in detail along with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

Hereinafter, in order to help understanding of those skilled in the art, a proposed background of the present disclosure is first described and an embodiment of the present disclosure is then described.

The autonomous driving technology is the result of an advanced artificial intelligence technology that enables a vehicle to autonomously perceive a surrounding environment, decide a driving route, and perform a control instruction, and is recently rapidly developed. In particular, in order to implement stable and efficient autonomous driving in an actual driving environment in which a road condition is constantly changing, it is very important for a vehicle to accurately perceive the driving environment in real time and to immediately reflect the result of the perception into a decision-making process. Accordingly, a real-time driving environment perception technology is emerging as a core task of the autonomous driving field.

However, most conventional autonomous driving systems adopt a structure in which data obtained from individual sensors, such as a camera, LiDAR, and a GPS, is independently processed and the results of the processing are integrated in a rule-based way. In such a method, a comprehensive decision on a complex road condition or a sudden environment change is difficult because only limited information for each sensor is processed. Furthermore, the method has a problem in that latency occurs in an information transfer process between steps because perception and decision functions operate by being separated into separate modules. Furthermore, the method has a problem in that it is difficult to make an immediate and consistent decision in a complex downtown environment, an intersection, or a multi-lane expressway situation that requires a real-time response.

Recently, as a vision-language model (VLM) technology capable of integrally processing an image and a natural language emerges, a new artificial intelligence paradigm in which visual information and linguistic information can be simultaneously understood and described is suggested. Such a technology has potential of describing and interpreting a driving environment in a way similar to a human beyond the level of simply perceiving a visual object. However, in order to directly apply the unified VLM to a real-time autonomous driving environment, there are still many technological challenges to be solved.

In particular, processing large volumes of data from multi-modal sensors in real time, while predicting the movements of surrounding dynamic objects (e.g., pedestrians, vehicles, or obstacles) and establishing safe and rational driving strategies based on such predictions, remains as a technical challenge. In conventional autonomous driving technologies, functions, such as object detection, path planning, and vehicle control, are developed as separate modules, and are integrated into a single system. As a result, the overall complexity of the driving strategy learning system increases. In cases where decisions from different modules conflict, no systematic mechanism exists to coordinate them, ultimately reducing real-time performance and system stability.

Furthermore, the existing system has limitations in that it is difficult to effectively reflect intuitive judgment or a context-aware decision that is empirically performed by a human driver. For example, a person comprehensively perceives a situation on a road and naturally makes a decision “I should yield,” or “I have to give it back” through linguistic and situational context, but it is difficult for the existing rule-based algorithm to numerically model such a complex decision.

In order to overcome such limitations, recently, an end-to-end learning method of directly receiving sensor data obtained from a camera and LiDAR, integrally interpreting the sensor data, and immediately deriving a driving strategy has been in the spotlight as a new alternative. The end-to-end learning method is an approach in which perception-decision-control steps are bound as one integrated learning model and a vehicle autonomously learns an optimal decision rule based on driving data.

Accordingly, in order for an autonomous driving system to make a rapid and accurate decision in an actual road environment, a real-time driving strategy learning technology based on a unified vision-language model (VLM) is essentially required. Such a technology becomes a core base on which an autonomous driving system can develop into a safer and more intelligent autonomous driving system by overcoming the existing segmental structure and internationalizing the intuitive judgment of a human driver in a learnable form.

Based on the aforementioned background, embodiments of the present disclosure enable the fundamental resolution of information latency and inefficiency that arise from the separation of perception-decision-control stages in an autonomous driving system.

According to embodiments of the present disclosure, based on the unified VLM, a driving environment is comprehensively perceived by combining visual information and linguistic semantic information obtained from sensor data and a step-by-step bottleneck of the existing system is removed by reflecting the result of the combination in immediate decision-making.

Furthermore, according to embodiments of the present disclosure, a flexible reaction can be made through natural language-based situational understanding even in a complex and dynamic road condition. A vehicle is autonomously adapted to a change in the actual driving environment without relying on a pre-defined rule by integrally interpreting various visual elements and context information during driving through the unified VLM.

According to embodiments of the present disclosure, a driving strategy learning system can learn and continuously improve a situation decision ability having a level similar to the level of a human because the driving strategy learning system has a structure in which intuitive judgment and empirical knowledge of a human driver can be reflected in a real-time feedback form.

According to embodiments of the present disclosure, a safer, efficient, and human-friendly autonomous driving system can be implemented because the autonomous driving system autonomously learns and decides a driving strategy by interpreting a driving environment based on unified vision-language perception.

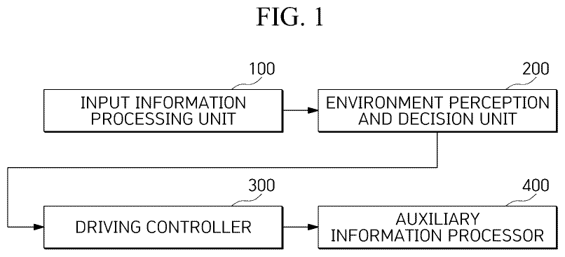

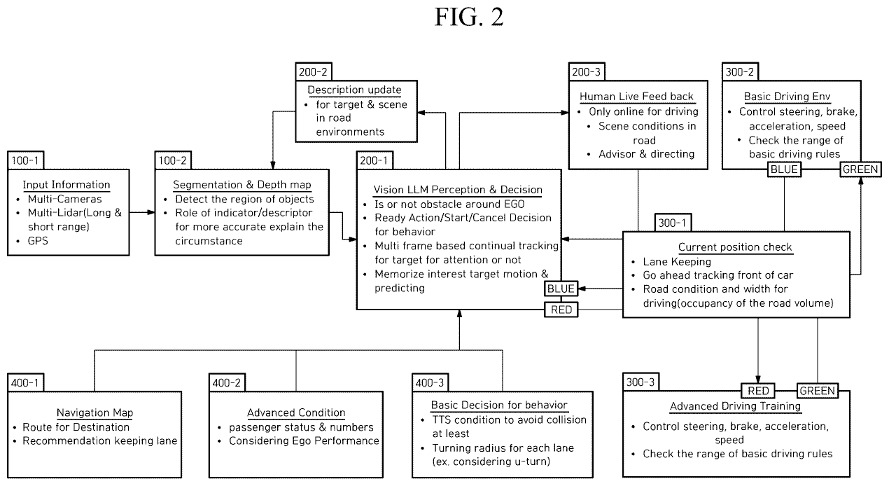

FIG. 1 illustrates a driving strategy learning system based on unified vision-language perception in a real-time driving environment according to an embodiment of the present disclosure. FIG. 2 is a detailed configuration diagram of the driving strategy learning system based on unified vision-language perception in a real-time driving environment according to an embodiment of the present disclosure.

The driving strategy learning system based on unified vision-language perception in a real-time driving environment according to an embodiment of the present disclosure includes an input information processing unit 100, an environment perception and decision unit 200, a driving controller 300, and an auxiliary information processor 400.

The input information processing unit 100 performs a function for collecting multi-sensor data and pre-processing the multi-sensor data in a form suitable for the analysis of a driving environment. The input information processing unit 100 includes an input information collection module 100-1 and a segmentation and depth map generation module 100-2.

The input information collection module 100-1 includes a plurality of sensors, such as a multi-camera, long-range and short-range LiDAR sensor, and a GPS system.

The multi-camera provides a 360-degree viewing angle that covers all of the front, side, and rear of a vehicle. Each of the cameras operates with optimized resolution at an optimized frame rate. The LiDAR sensor includes long-range LiDAR capable of detecting a distance of 150 m or more and short-range LiDAR capable of measuring a precise distance of a region close to a vehicle, and simultaneously detects long-range and short-range obstacles. The GPS system secures high-precision position data by providing the position of a vehicle in real time and performing position correction and error supplementation in association with a navigation system.

The segmentation and depth map generation module 100-2 detects the region of an object based on multi-modal data obtained from the input information collection module 100-1, and analyzes relation and space information between objects. The segmentation and depth map generation module 100-2 segments and classifies a road, a vehicle, a pedestrian, and an obstacle within an image in real time, and precisely detects boundaries between objects. Furthermore, the segmentation and depth map generation module 100-2 generates a depth map in a three-dimensional space by extracting contextual information of a road environment and analyzing a mutual relation between objects.

The generated depth map is used as the input of a unified vision-language model (VLM), and enables both depth-based detection and natural language-based narrative understanding for a driving environment.

The environment perception and decision unit 200 interprets a driving environment at a level similar to the level of a human based on the unified VLM and makes a driving decision. The environment perception and decision unit 200 includes a vision large language model (LLM) perception and decision module 200-1, a description update module 200-2, and a human live feedback module 200-3.

The vision LLM perception and decision module 200-1 decides whether an obstacle is present around a vehicle (EGO vehicle) and decides one driving state, among Ready/Action/Start/Cancel states. The vision LLM perception and decision module 200-1 memorizes and predicts a motion of an interest target through multi-frame-based target tracking, identifies static and dynamic obstacles, and analyzes the avoidance possibility of each of the static and dynamic obstacles. Furthermore, the result of the decision is generated as a situation description in a natural language form through the unified VLM and is transmitted so that another module of the driving strategy learning system can refer to the situation description.

The description update module 200-2 updates a natural language description of a current driving situation in real time based on the result of the analysis of the vision LLM perception and decision module 200-1. In particular, the description update module 200-2 highlights and represents a risk factor, and preferentially processes important information by setting the priority of a situation when a change in the road environment or an event occurs. Accordingly, the driving strategy learning system can perform contextual decisions and descriptions at a level, which may be understood by a human driver, beyond the simple perception of a target.

The human live feedback module 200-3 collects natural language-based real-time feedback that is provided from a driver during driving and reflects the feedback in a decision-making process of the driving strategy learning system. A driver may provide feedback, such as road hazards, priority measures, and decision supplementation in a voice or text form. The human live feedback module 200-3 classifies and analyzes the feedback and converts the feedback in a machine-usable data form. The human live feedback module 200-3 operates in an online state only during driving, verifies and corrects a system decision, and also performs functions for reflecting an expert advice, providing safe driving guidelines, and generating hazard situation warning.

The driving controller 300 executes a control instruction of an actual vehicle based on a decision result calculated through the unified VLM. The driving controller 300 includes a current position check module 300-1, a basic driving environment control module 300-2, and an advanced driving training module 300-3.

The current position check module 300-1 performs vehicle perception, the tracking of a preceding vehicle, and the calculation of a road width and a road volume share. Accordingly, a vehicle is controlled to check a space in which the vehicle can drive in real time, maintain a safe distance from a preceding vehicle, and to be positioned at the center of a lane.

The basic driving environment control module 300-2 is responsible for basic driving functions, such as steering, acceleration, braking, and speed control, and continuously checks compliance with traffic regulations and basic driving rules. The basic driving environment control module 300-2 optimizes a basic control element by reflecting a decision result transmitted by the vision LLM perception and decision module 200-1.

The advanced driving training module 300-3 establishes an advanced driving strategy in a more complex road condition or an exceptional condition based on the basic driving functions. The advanced driving training module 300-3 decides an optimal driving route for each condition by finely adjusting steering, braking, and acceleration, and realizes optimal control performance within the range of the basic driving rules. The advanced driving training module 300-3 performs mutual supplementation control through the exchange of information with the basic driving environment control module 300-2, and increases overall driving stability.

The auxiliary information processor 400 performs an auxiliary decision element and external information integration function for establishing a driving strategy. The auxiliary information processor 400 includes a navigation map module 400-1, an advanced condition decision module 400-2, and a basic behavior decision module 400-3.

The navigation map module 400-1 calculates an optimal route to a destination, and updates recommendation lane and turning information by reflecting real-time traffic information. The recommendation lane and turning information is transmitted to the vision LLM perception and decision module 200-1 and the current position check module 300-1 and is used as a core input for a driving strategy decision.

The advanced condition decision module 400-2 continuously monitors the internal state (e.g., the number of passengers, a degree of fatigue, or a vehicle performance state) of a vehicle, and provides corresponding information to the environment perception and decision unit 200. Accordingly, the driving strategy learning system can establish a condition-adaptive driving strategy by considering the physical limitations of a vehicle and a passenger status.

The basic behavior decision module 400-3 is a core element that is responsible for a safe decision, and evaluates the level of the collision risk by calculating a time to collision (TTC) value in real time. Furthermore, the basic behavior decision module 400-3 decides the execution possibility of a complex driving operation, such as U turning, avoidance, or a lane change, by considering a turning radius and road occupancy by lane. The result of the decision of the basic behavior decision module 400-3 is transmitted to the driving controller 300, thus guaranteeing both safety and efficiency.

According to embodiments of the present disclosure, in the driving strategy learning system, interactions between the modules are performed as follows. Bidirectional information exchange paths indicated by a red node and a blue node in FIG. 2 are formed between the vision LLM perception and decision module 200-1 and the current position check module 300-1. This means that perception and control are closely associated. Specifically, an environment perception result is immediately reflected in driving control without latency. In contrast, a control execution result is fed back to the vision LLM perception and decision module 200-1 again and is used to gradually increase perception accuracy.

Furthermore, the exchange of information between the basic driving environment module 300-2 and the advanced driving training module 300-3 is indicated by a green node in FIG. 2. This indicates that basic vehicle control is continuously optimized by an advanced driving strategy and an advanced driving strategy is established within a practically executable range by considering the physical and operational limitations of basic control. Such an interaction structure has a technological meaning in which all of reactivity, stability, and accuracy at the entire system level are secured through mutual supplementation without harming the independent availability of each module.

According to embodiments of the present disclosure, the following detailed operation is performed for each major driving scenario.

In an obstacle avoidance scenario, when the input information collection module 100-1 detects an obstacle on a road, the segmentation and depth map generation module 100-2 calculates an accurate position and size of the obstacle. Next, the vision LLM perception and decision module 200-1 determines whether avoidance is necessary. The description update module 200-2 generates a natural language description of the current situation, clarifying the nature and priority of the hazard. When the current position check module 300-1 identifies a surrounding drivable space, the basic driving environment module 300-2 and the advanced driving training module 300-3 cooperatively execute an avoidance behavior, such as steering, acceleration, or deceleration.

In a lane change scenario, the input information processing unit 100 identifies information on the position and attribute of a surrounding vehicle. The vision LLM perception and decision module 200-1 decides the possibility and timing of a lane change. The driving controller 300 performs a lane change that is optimized as a route having a minimized collision risk by synthesizing recommended lane information provided by the navigation map module 400-1 and an actual lane-changeable space calculated by the current position check module 300-1.

In an intersection driving scenario, when the input information processing unit 100 collects the geographical features, signal, and traffic flow of the entire intersection area, the vision LLM perception and decision module 200-1 comprehensively analyzes the state of traffic lights and a movement of another vehicle or a pedestrian. The advanced condition module 400-2 checks a current driving condition, such as vehicle performance and a passenger status. The basic behavior decision module 400-3 calculates a safe stop distance. The modules of the driving controller 300 cooperatively execute an intersection passing strategy, such as a stop, a start, and left and right turns.

In an emergency situation reaction scenario, data collected from all of the sensors is transmitted to the vision LLM perception and decision module 200-1 within 50 ms. The vision LLM perception and decision module 200-1 immediately decides a dangerous situation. The description update module 200-2 highlights a risk factor by generating emergency situation notification. All of the modules of the driving controller 300 perform an immediate avoidance operation. The basic behavior decision module 400-3 rearranges control priority by establishing a collision damage minimization strategy. The series of scenario operations have a technical effect in that they provide a stable and consistent reaction in various situations, such as downtown, high speed, and crowded environments, by binding all of processes, such as detection, understanding, a decision, and execution, in the form of a real-time closed loop.

According to embodiments of the present disclosure, in a step of collecting and pre-processing sensor data, data is collected from a multi-camera, LiDAR, and a GPS. Segmentation and depth information is generated by pre-processing and synchronizing the collected data in real time.

In an environment perception and decision-making step, based on the unified VLM, the perception of an integrated environment is performed, a natural language description for a current situation is generated, and human feedback is collected from a driver and reflected in a decision.

In a driving control execution step, a current state is identified, a basic control instruction is generated, and an advanced driving strategy is applied. Each control instruction guarantees a process time within 100 ms. In particular, in an emergency situation, each control instruction operates with a response time within 50 ms.

In an auxiliary information utilization step, route planning is established. The state of a vehicle and a passenger is monitored. Final safety verification is performed. Auxiliary information that is obtained as described above is continuously reflected in a strategic decision.

Major characteristic functions according to an embodiment of the present disclosure include an integrated environment perception function, a real-time driving control function, and a safety guarantee function, and they continuously operate.

In terms of the integrated environment perception function, multi-sensor data of the input information collection module 100-1 is processed through the segmentation and depth map generation module 100-2. The vision LLM perception and decision module 200-1 performs integrated situation understanding. The description update module 200-2 generates a situation description based on a natural language. Verification and corrections are performed through the human live feedback module 200-3.

In terms of the real-time driving control function, the current position check module 300-1 identifies a state in real time. The basic driving environment module 300-2 generates a basic control instruction. The advanced driving training module 300-3 applies an optimized driving strategy. The current position check module, the basic driving environment module, and the advanced driving training module continuously optimize control through the exchange of information.

In terms of the safety guarantee function, the basic behavior decision module 400-3 makes a collision avoidance decision based on a time to collision (TTC). The advanced condition module 400-2 monitors vehicle and passenger statuses. The navigation map module 400-1 provides route and lane information. In each decision step, multi-safety verification is performed. These functions are properly combined in parallel and series in a single pipeline and connect all of the processes, such as situation perception, a decision, control, and verification, without a data loss.

According to embodiments of the present disclosure, the modules are designed to be organically connected while independently operating, and are designed to maintain the safety of the entire driving strategy learning system although a temporary function reduction occurs in a specific module. The exchange of information between the modules is performed through a standardized protocol. The possibility of prediction for real-time processing is guaranteed because priority is assigned depending on the priority level of data and an event.

Major communication paths of the driving strategy learning system according to an embodiment of the present disclosure are organized as a sensor data path, a control instruction path, and an auxiliary information path.

In the sensor data path, real-time data is transmitted from the input information collection module 100-1 to the segmentation and depth map generation module 100-2. Processed data is transmitted to the vision LLM perception and decision module 200-1. An environment perception result is transmitted to the description update module 200-2 again.

In the control instruction path, the decision result of the vision LLM perception and decision module 200-1 is transmitted to the driving controller 300. The exchange of bidirectional information is performed between the basic driving environment module 300-2 and the advanced driving training module 300-3. Information on the state of the current position check module 300-1 is shared in the entire driving strategy learning system.

In the auxiliary information path, route information of the navigation map module 400-1 is transmitted to the vision LLM perception and decision module 200-1. Information on the state of the advanced condition module 400-2 is provided to the entire driving strategy learning system in real time. The safe decision result of the basic behavior decision module 400-3 is transmitted to the driving controller 300. Such a communication path is designed to allow cross reference at a required point while separating data flows for each function, thus satisfying all of data consistency, time limitation compliance, and safety verification.

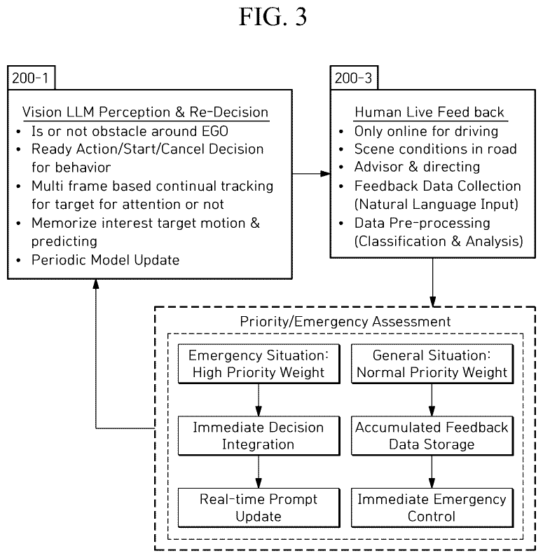

FIG. 3 illustrates a data processing structure including the vision LLM perception and re-decision module, the human live feedback module, and the priority and emergency level decision module according to another embodiment of the present disclosure.

According to embodiments of the present disclosure, in the decision and control process of an autonomous vehicle, a data processing method of performing a more precise and safer driving decision by integrally reflecting real-time feedback from a human driver is provided.

The vision LLM perception and re-decision module 200-1 and the human live feedback module 200-3 are interconnected and operated. Decision information generated by the vision LLM perception and re-decision module 200-1 and the human live feedback module 200-3 is transmitted to the priority and emergency level decision module. Accordingly, a decision-making processing sequence is dynamically adjusted depending on the emergency and priority levels of a situation.

The vision LLM perception and re-decision module 200-1 perceives a surrounding environment of an autonomous vehicle (EGO vehicle) in real time and performs a decision necessary for driving. The vision LLM perception and re-decision module 200-1 detects whether an obstacle is present based on data received from a camera and a LiDAR sensor, and decides the switching of a state, such as Ready, Start, Cancel, and Action states of a driving behavior. In particular, the vision LLM perception and re-decision module 200-1 can decide a dangerous situation in the future by storing a moving pattern of an interest target, such as a surrounding vehicle or pedestrian, in a memory form and predicting a motion of the interest target through a multi-frame-based target tracking function.

The vision LLM perception and re-decision module 200-1 continuously improves perception performance according to an environment change or a road type by performing periodic model updates. The perception result of the vision LLM perception and re-decision module 200-1 is transmitted to the entire driving strategy learning system along with a description in a natural language form.

The human live feedback module 200-3 collects intuitive judgment information provided by a human driver during driving, and reflects the intuitive judgment information in a decision-making process of the driving strategy learning system. The driver may provide feedback for a road condition, a risk factor, or decision supplementation in a voice or text form. The human live feedback module 200-3 converts the feedback into data that is suitable for machine learning through a classification and analysis process. The feedback is used to supplement complex context that is not detected by the driving strategy learning system or a human-specific situation interpretation ability. The human live feedback module 200-3 is maintained in an online state only during driving, and includes functions, such as suggesting safe driving guidelines, generating danger warning, and reflecting expert advice.

Information generated by the vision LLM perception and re-decision module 200-1 and the human live feedback module 200-3 is input to the priority and emergency level decision module. The priority and emergency level decision module evaluates an emergency level and a priority level for each situation. The priority and emergency level decision module dynamically adjusts process priority by synthesizing feedback data and a perception result. When a current situation is classified as an emergency situation, decision-making is immediately integrated and reflected in a control instruction in real time. In this process, a real-time prompt update function is performed, the prompt of a vision LLM is immediately modified, and a new decision is reflected.

Furthermore, in an emergency situation, such as an accident or a sudden stop, immediate emergency control is triggered. An instruction is first transmitted to each of the modules of the driving controller 300.

In contrast, in a common situation, feedback data is accumulated and stored and is subsequently reflected in the learning of a driving strategy. Such data is used in a model parameter update process so that the driving strategy learning system can continuously improve the decision ability based on experiences.

Through the structure illustrated in FIG. 3, an autonomous driving system can secure high stability and reaction even in a complex road environment by integrating a human's intuitive judgment and an artificial intelligence-based perception result. That is, data processing architecture which enables a driving strategy decision is implemented by comprehensively evaluating various situations occurring in a real-time driving environment based on a vision-language perception result and a human's feedback information.

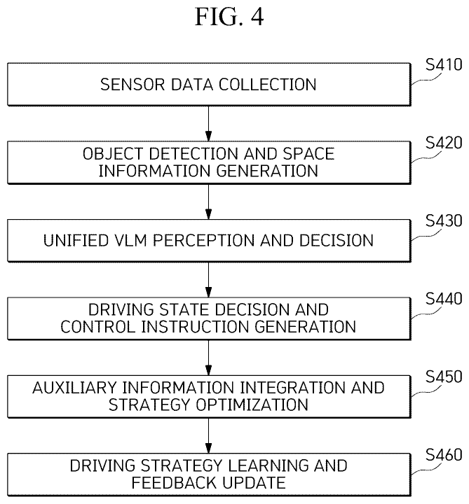

FIG. 4 illustrates a driving strategy learning method based on unified vision-language perception in a real-time driving environment according to an embodiment of the present disclosure.

The driving strategy learning method based on unified vision-language perception in a real-time driving environment according to an embodiment of the present disclosure includes a series of procedures of learning and updating, by a vehicle, a driving strategy by integrally perceiving various sensor data that is collected during driving through a unified vision-language model (VLM) and reflecting real-time feedback from a human driver.

The driving strategy learning method based on unified vision-language perception in a real-time driving environment according to an embodiment of the present disclosure includes a sensor data collection step S410, an object detection and space information generation step S420, a unified vision-language perception and decision step S430, a driving state decision and control instruction generation step S440, an auxiliary information integration and strategy optimization step S450, and a driving strategy learning and feedback update step S460.

In step S410, driving environment data is collected in real time through a plurality of sensors, such as a camera, LiDAR, and a GPS. The data collected in step S410 includes ahead, behind, and side videos of a vehicle, distance information of the vehicle, and position coordinates of the vehicle. Each of the plurality of sensors guarantees real time by updating data in a cycle of 100 ms or less during driving. The sensor data is obtained through the input information collection module 100-1 of the input information processing unit 100. Time axis alignment and coordinate conversion are performed between different sensors, and the sensor data are pre-processed in a synchronized form.

In step S420, object detection and the generation of space information are performed through the segmentation and depth map generation module 100-2. In step S420, image data obtained from the plurality of sensors is subdivided into a pixel unit and classified into roads, vehicles, pedestrians, or obstacles. The depth and position of each object is mapped on a three-dimensional coordinate system. Accordingly, the vehicle can stereoscopically understand a surrounding environment and can numerically check a distance and collision possibility between obstacles.

In step S430, the vision LLM perception and decision module 200-1 of the environment perception and decision unit 200 operates, integrally analyzes visual information and language information, and interprets a driving situation. In step S430, the driving strategy learning system generates a natural language description for a current situation by synthesizing a motion of an object, a form of a road, and a signal state. When a risk factor is detected, the driving strategy learning system assigns priority. Furthermore, when intuitive judgment is received from a driver through the human live feedback module 200-3, the driving strategy learning system reflects corresponding feedback as learning data so that the VLM re-decides its decision. In this process, the priority and emergency level decision module evaluates the priority and danger levels of each event, and transmits a signal so that an immediate control instruction is generated when the event corresponds to an emergency situation.

In step S440, an actual control instruction for the vehicle is generated through the driving controller 300. The current position check module 300-1 decides a drivable area by analyzing the lane of the vehicle, a distance from a preceding vehicle, and the width of a road. The basic driving environment control module 300-2 performs basic control, such as steering, acceleration, and braking. The advanced driving training module 300-3 applies an optimal control strategy by considering traffic density, a turning radius, and road occupancy, and performs an immediate control instruction with a response time of 50 ms or less in an emergency situation.

In step S450, a driving strategy is optimized by integrating additional data, such as navigation map information, vehicle state information, and a passenger status that are provided by the auxiliary information processor 400. The navigation map module 400-1 provides information on a destination route and a recommended lane. The advanced condition decision module 400-2 sets a suitable driving condition by reflecting performance state of the vehicle and a passenger status. Furthermore, the basic behavior decision module 400-3 decides a collision avoidance possibility by calculating a time to collision (TTC) value, and performs an emergency stop or avoidance control, if necessary.

In step S460, the learning of a driving strategy is performed through an interaction between the vision LLM perception and decision module 200-1 and the human live feedback module 200-3. Data and feedback that are generated during driving are accumulated and stored and are used as learning data. Perception accuracy and decision confidence are improved through periodic model updates. Accordingly, the driving strategy learning system can acquire the ability to understand a situation, which has a level equal to the level of a human driver, and an intuitive judgment ability through repetitive driving.

According to embodiments of the present disclosure, an autonomous vehicle can autonomously understand an environment and continuously learn and update a safe and efficient driving strategy by comprehensively using real-time sensor data, unified vision-language perception results, and human feedback information. Accordingly, it is possible to overcome the limitations of the existing rule-based autonomous driving system and to implement a next-generation autonomous driving system having a human-level judgment and adaptability.

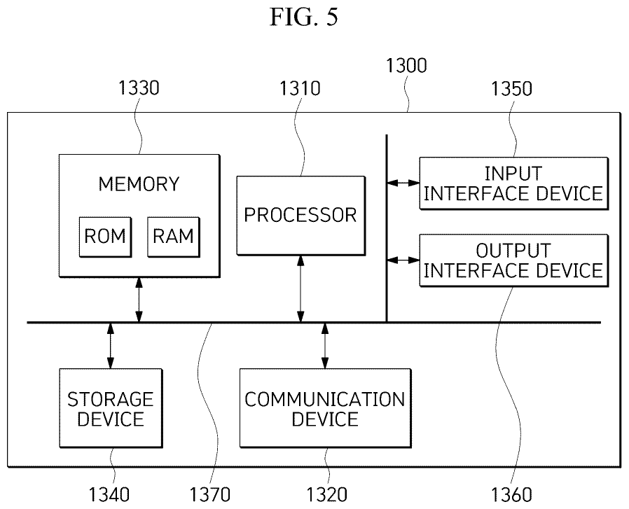

FIG. 5 is a block diagram illustrating a computer system for implementing a method according to an embodiment of the present disclosure.

Referring to FIG. 5, a computer system 1300 may include at least one of a processor 1310, memory 1330, an input interface device 1350, an output interface device 1360, and a storage device 1340, which perform communication through a bus 1370. The computer system 1300 may further include a communication device 1320 that is connected to a network. The processor 1310 may be a central processing unit (CPU) or may be a semiconductor device that executes a command stored in the memory 1330 or the storage device 1340. The memory 1330 and the storage device 1340 may include various forms of volatile or nonvolatile storage media. For example, the memory may include read only memory (ROM) and random access memory (RAM). In an embodiment of this specification, the memory may be disposed inside or outside the processor. The memory may be connected to the processor through various already-known means. The memory may be various forms of volatile or nonvolatile storage media. For example, the memory may include read-only memory (ROM) or random access memory (RAM).

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes made by those skilled in the art using the basic concept of the present disclosure defined in the appended claims are also included in the scope of rights of the present disclosure.

What is claimed is:

1. A driving strategy learning system based on unified vision-language perception in a real-time driving environment, the driving strategy learning system comprising:
an input information processing unit configured to collect and pre-process multi-sensor data;
an environment perception and decision unit configured to interpret a driving environment and to perform a driving decision based on a unified vision-language mode (VLM);
a driving controller configured to generate and execute a vehicle control instruction based on the driving decision; and
an auxiliary information processor configured to support a driving strategy decision by integrating auxiliary information comprising at least any one of a navigation route, vehicle and passenger statuses, and a time to collision (TTC)-based collision risk index.

2. The driving strategy learning system of claim 1, wherein the input information processing unit comprises:
an input information collection module configured to collect driving environment data through a plurality of sensors comprising a multi-camera, long-range LiDAR, short-range LiDAR, and a GPS; and
a segmentation and depth map generation module configured to detect a region of an object and to generate a depth map based on the multi-sensor data.

3. The driving strategy learning system of claim 1, wherein the environment perception and decision unit comprises:
a vision large language model (LLM) perception and decision module configured to decide whether an obstacle is present around a vehicle and decide a Ready, Action, Start, or Cancel state;
a description update module configured to describe a perception result in a natural language form and to represent a risk factor by highlighting the risk factor; and
a human live feedback module configured to collect feedback from a driver in real time during driving and to reflect the feedback in a decision.

4. The driving strategy learning system of claim 3, wherein the vision LLM perception and decision module predicts a motion of an interest target by performing multi-frame-based target tracking and analyzes avoidance possibility by separately identifying a static obstacle and a dynamic obstacle.

5. The driving strategy learning system of claim 3, wherein the human live feedback module converts the feedback of the driver in a voice or text form into machine learning data by classifying and analyzing the feedback during driving.

6. The driving strategy learning system of claim 1, wherein the driving controller comprises:
a current position check module configured to calculate a current position of a vehicle by performing vehicle perception, preceding vehicle tracking, and road width calculation;
a basic driving environment control module configured to perform steering, acceleration, braking, and speed control; and
an advanced driving training module configured to establish an advanced driving strategy.

7. The driving strategy learning system of claim 6, wherein:
the basic driving environment control module and the advanced driving training module optimize a result of basic control as an advanced strategy by performing an exchange of bidirectional information, and
the advanced strategy is established within an executable range by considering limitations of the basic control.

8. The driving strategy learning system of claim 1, wherein the auxiliary information processor comprises:
a navigation map module configured to calculate an optimal route to a destination and to update recommendation lane and turning information by reflecting real-time traffic information;
an advanced condition decision module configured to monitor a number of passengers within a vehicle, a degree of fatigue, and a vehicle performance state; and
a basic behavior decision module configured to evaluate a level of a collision risk by calculating a TTC value.

9. The driving strategy learning system of claim 8, wherein the basic behavior decision module decides an execution possibility of U turning, avoidance, and a lane change by considering a turning radius and road occupancy by lane and transmits a safe stop distance calculation result to the driving controller.

10. The driving strategy learning system of claim 1, wherein a bidirectional information exchange path is formed between the environment perception and decision unit and the driving controller so that a perception result is reflected in real-time driving control and a control result is used to improve perception accuracy again.

11. The driving strategy learning system of claim 1, wherein the environment perception and decision unit comprises a priority and emergency level decision module configured to receive decision information generated by a vision LLM perception and re-decision module and a human live feedback module, to evaluate emergency and priority levels of a situation, and to dynamically adjust processing priority.

12. The driving strategy learning system of claim 11, wherein the priority and emergency level decision module calculates the emergency and priority levels for each situation by integrating a perception result of the vision LLM perception and re-decision module and feedback data of the human live feedback module and performs real-time prompt updates when each situation is classified as an emergency situation.

13. The driving strategy learning system of claim 11, wherein the priority and emergency level decision module preferentially transmits an instruction to each module of the driving controller by immediately triggering emergency control when an emergency situation occurs, and accumulates and stores feedback data and reflects the feedback data in a learning of the driving strategy in a common situation.

14. A driving strategy learning method based on unified vision-language perception in a real-time driving environment, the driving strategy learning method performed by a driving strategy learning system based on unified vision-language perception in a real-time driving environment comprising:
collecting driving environment data from a multi-modal sensor;
perceiving an object and generating space information comprising a depth map based on the collected driving environment data;
interpreting a driving environment and deciding a situation by using a unified vision-language model (VLM);
determining a driving state of a vehicle and generating a control instruction comprising steering, acceleration, braking, and speed control based on a result of the situation decision;
optimizing a driving strategy by integrating auxiliary information comprising at least any one of a navigation route, vehicle and passenger statuses, and a time to collision (TTC)-based collision risk index; and
updating the unified VLM by reflecting a driving result and human feedback and performing a learning of the driving strategy.

15. The driving strategy learning method of claim 14, wherein the collecting of the driving environment data from the multi-modal sensor comprises:
collecting data covering front, rear, and side areas of the vehicle through a multi-modal sensor comprising a camera, LiDAR, and a GPS at a preset cycle or less, and
pre-processing the driving environment data in a synchronized form by performing time axis alignment and coordinate conversion on the driving environment data.

16. The driving strategy learning method of claim 14, wherein the perceiving of the object and the generating of the space information comprising the depth map comprises:
segmenting input image data in a pixel unit by using a segmentation and depth map generation module, and
mapping a position and depth of each object on a three-dimensional coordinate system by detecting boundaries between a road, a vehicle, a pedestrian, and an obstacle.

17. The driving strategy learning method of claim 14, wherein the interpreting of the driving environment and deciding of the situation by using the unified VLM comprises:
integrating and analyzing visual information and language information through a vision LLM perception and decision module,
generating a natural language description for a current situation by synthesizing a motion of the object, a road form, and a signal state,
assigning emergency and priority levels of an event through a priority and emergency level decision module when a risk factor is detected, and
outputting an immediate control instruction generation signal by performing real-time prompt updates when the current situation is classified as an emergency situation.

18. The driving strategy learning method of claim 14, wherein the interpreting of the driving environment and deciding of the situation by using the unified VLM comprises:
collecting intuitive judgment information of a driver through a human live feedback module,
re-adjusting a unified vision-language perception result by reflecting the intuitive judgment information in learning data, and
generating an immediate control instruction when an emergency situation occurs by evaluating priority and emergency levels of an event through a priority and emergency level decision module.

19. The driving strategy learning method of claim 14, wherein the determining of the driving state of the vehicle and generating of the control instruction based on the situation decision result comprises:
calculating vehicle perception, preceding vehicle tracking, and a road width through a current position check module,
generating a control instruction comprising steering, acceleration, and braking through a basic driving environment control module and an advanced driving training module, and
performing an immediate control instruction within a preset response time or less in an emergency situation.

20. The driving strategy learning method of claim 14, wherein the optimizing of the driving strategy by integrating the auxiliary information comprises:
providing destination route and recommended lane information through a navigation map module,
reflecting vehicle performance and a passenger status through an advanced condition decision module,
deciding whether to avoid a collision by calculating a TTC value through a basic behavior decision module, and
performing at least one of urgent stop control and avoidance control.
